(19) United States
(12) Patent Application Publication
(10) Pub. No.: US 2020/0315202 A1
(43) Pub. Date: Oct. 8, 2020

(54) Soluble Tea Extract Tablet and Method of Manufacturing

(71) Applicant: Shlomo Matan Avshalom, Adi (IL)

(72) Inventor: Shlomo Matan Avshalom, Adi (IL)

(21) Appl. No.: 16/375,857

(22) Filed: Apr. 5, 2019

(51) Int. Cl. A23F 3/32; A23F 3/22; A23F 3/18; A23F 3/40

(52) U.S. Cl. CPC A23F 3/32; A23F 3/40; A23F 3/18; A23F 3/22

(57) ABSTRACT

A soluble tea extract tablet that consists of homogenous mixture of dried tea extract and sugar and a method of manufacturing this soluble tea extract tablet that use the following equipment and materials and the following steps: providing tea leaves, sugar, water and a container. Pouring the water into the container and putting the tea leaves and the sugar inside the container. Heating the container and evaporating the water. Removing the tea leaves and continuing the heating until obtaining a homogenous viscous mixture of tea extract and sugar. Creating pieces from the viscous mixture and drying them for forming the soluble tea extract tablets.

### TECHNICAL FIELD

The present invention refers to a soluble tae extract tablets and a method for manufacturing these tea extract tablets.

### BACKGROUND ART

Drinking tea is a common daily practice around the world. It is customary to consume tea packed in tea bags or tea leaves of various sizes, sometimes rolled and cut. The present invention discloses a soluble tea extract tablet as an additional new way for tea consumption and a method of manufacturing these tea tablets.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 depicts the soluble tea extract tablets (1).

FIG. 2 depicts the container (5) with water (4), tea leaves (2) and sugar (3).

### THE INVENTION

The main abject of the present invention is to provide a soluble tea extract tablet (1) and a method for manufacturing this tablet. The soluble tea extract tablet (1) consists of a homogenous mixture of dried tea extract and sugar.

By describing the method of manufacturing the soluble tea extract tablet (1) we can understated its essence and structure. The method of manufacturing the soluble tea extract tablet (1) includes the use of the following equipment and materials and the following steps:

(a) providing tea leaves (2), sugar (3), water (4) and container (5). The tea leaves may be of any kind of tea, black tea or green tea. The amount of tea leaves should match the amount of water and the amount of sugar when the goal is to create a concentrated tea drink dissolved in sugar. An efficient production process can be in relation to the following: 200 ml water, 10 grams sugar and 5 grams tea leaves.

(b) Pouring the water into the container and putting the tea leaves and the sugar inside the container. The order of putting these materials inside the container is not important, and the goal is that they all together, the tea leaves, the sugar and the water should be together inside the container.

(c) Heating the container with the water, the tea leaves and the sugar and evaporating the water by this heating process. The heating process should bring the water to a temperature in which the tea leaves will be brew efficiently and that the water will evaporate and that the sugar turn into a tire, and if the water will be about 60 degrees Celsius then the process can work quite fine.

(d) After a while when the tea leaves are brewed and the water in the container is actually a sort of tea concentrate, the tea leaves should be removed from the container and continuing the heating step until obtaining a homogenous viscous mixture of tea extract and sugar.

(e) Creating small pieces from the homogenous viscous mixture and drying these small pieces for forming the soluble tea extract tablets. The volume size of each soluble tea extract tablets can be about 1 cubic centimeter.

The user can put one, two or few soluble tea extract tablets into a cup with hot water for making a cup of tea. It is possible to sell a package of several soluble tea extract tablets in different flavors and different degree of sugar.

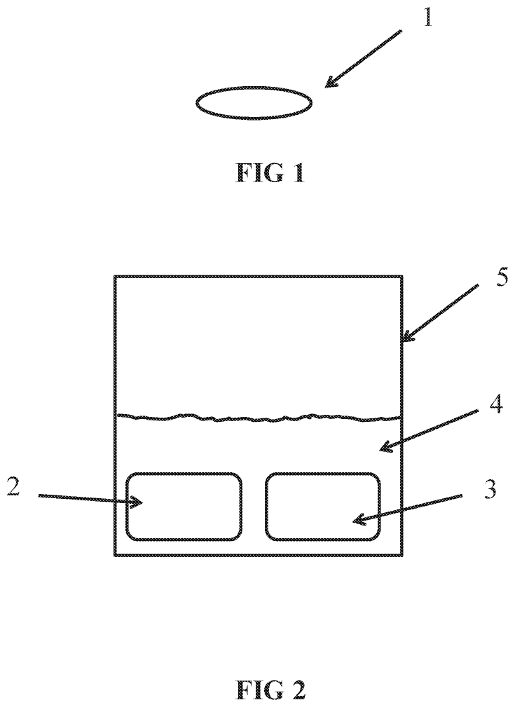

FIG. 1 depicts the soluble tea extract tablets (1) and FIG. 2 depicts the container (5) with water (4), tea leaves (2) and sugar (3).

What is claimed is:

1. A soluble tea extract tablet that consists of homogenous mixture of dried tea extract and sugar.

2. A method of manufacturing a soluble tea extract tablet (1) that consists of homogenous mixture of dried tea extract and sugar, comprising the use of the following equipment and materials and the following steps:
(a) providing tea leaves, sugar, water and a container;
(b) pouring the water into the container and putting the tea leaves and the sugar inside the container;
(c) heating the container with the water, the tea leaves and the sugar and evaporating the water by the heating process;
(d) removing the tea leaves from the container and continuing said heating step until obtaining a homogenous viscous mixture of tea extract and sugar;
(e) creating pieces from said homogenous viscous mixture and drying them for forming said soluble tea tablet;
whereby enabling a user to put one or more of said soluble tea extract tablets into a cup with hot water for making a cup of tea.
